(19) United States
(12) Patent Application Publication
(10) Pub. No.: US 2016/0334951 A1
(43) Pub. Date: Nov. 17, 2016

(54) DATA EXCHANGE USING PROXY

(71) Applicant: SAP SE, Walldorf (DE)

(72) Inventor: CHRISTIAN DENKEL, Sankt Leon-Rot (DE)

(21) Appl. No.: 14/709,504

(22) Filed: May 12, 2015

(51) Int. Cl. G06F 3/0483

(52) U.S. Cl. CPC G06F 3/0483

(57) ABSTRACT

Proxy controls are generated for corresponding original controls. An input is received in the proxy controls in a personalized user interface. The input received may be in a read mode or write mode. Based on the received input, it is determined whether the corresponding original controls are located on a deactivated tab page. Upon determining that the corresponding original controls are located on the deactivated tab page, the deactivated tab page is activated. Data is exchanged between the proxy controls and the corresponding original controls in the deactivated tab page. In data exchange, if the input received is in read mode, data is read from the original controls to the proxy controls. In data exchange, if the input received is in write mode, data is written into the original controls from the proxy controls.

### BACKGROUND

Enterprises use enterprise resource planning (ERP) applications for their business needs. The ERP applications are typically a suite of integrated applications involving collection, storage, management and interpretation of data from various business activities. The ERP applications may involve complex user interface screens with different data fields to provide various functionalities. To improve usability for an end user working with such ERP applications, ERP screens could be simplified. For example, some ERP applications may involve controls such as tab controls with multiple tabs, and the individual tabs may encompass individual pages. Data fields from multiple tabs may be available in a simplified screen. When the end user works with the simplified screen, it is challenging to update the data from the simplified screen to the different ERP screens.

### BRIEF DESCRIPTION OF THE DRAWINGS

The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating an exemplary tab strip control in an ‘enterprise GUI’, according to an embodiment.

FIG. 2 is a block diagram illustrating an exemplary personalized screen with data from various tab pages of ‘enterprise GUI’, according to an embodiment.

FIG. 3A is a block diagram and FIG. 3B is a set of table in combination illustrating data exchange using proxies and generated tables, according to an embodiment.

FIG. 4 is a high level flow diagram illustrating process of data exchange using proxy, according to one embodiment.

FIG. 5 is a detailed flow diagram illustrating process of data exchange using proxy, according to one embodiment.

FIG. 6 is a block diagram illustrating an exemplary computer system, according to one embodiment.

### DETAILED DESCRIPTION

Embodiments of techniques for data exchange using proxy are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

ERP applications manage information flow between different business functions and manage data associated with various business functions. The ERP applications may provide complex functionalities in various graphical user interface (GUI) screens referred to as ‘enterprise GUI’. The ‘enterprise GUI’ may be client software used to access enterprise applications installed and executing in a central server. The ‘enterprise GUI’ may be used to establish connectivity with the enterprise applications and to work with various functionalities of the enterprise applications. The ‘enterprise GUI’ may have various graphical control elements or widgets such as button, labels, etc., or grouped widgets such as windows, panels, tabs, etc., to interact with the enterprise application.

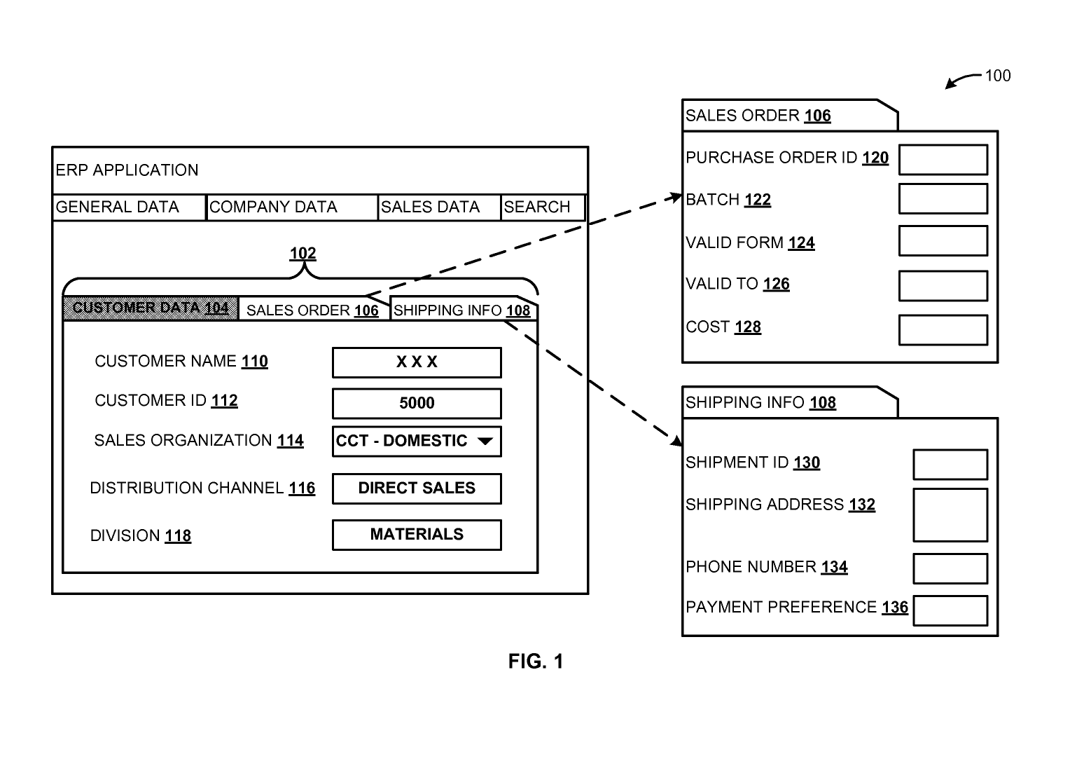

Tab strip control is a screen object consisting of multiple tab pages. Individual tab page in the tab strip control consists of a tab title and a page area. Tab strip controls allow a series of screens belonging to an application be placed on a single screen. FIG. 1 is a block diagram illustrating an exemplary tab strip control in ‘enterprise GUI’ 100, according to one embodiment. The ‘enterprise GUI’ 100 of an ERP application is shown with tab ‘strip control’ 102 referred to as original tab strip control, including various tab titles such as customer data 104, ‘sales order’ 106, and ‘shipping info’ 108. The individual tab titles have corresponding tab pages with appropriate data fields. For example, the ‘customer data’ 104 tab page has various data fields such as customer name 110, ‘customer id’ 112, ‘sales organization’ 114, ‘distribution channel’ 116 and ‘division’ 118. The ‘sales order’ 106 tab page has various fields such as ‘purchase order id’ 120, batch 122, valid from 124, valid to 126, and cost 128. The ‘shipping info’ 108 tab page has various fields such as ‘shipment id’ 130, ‘shipping address’ 132, ‘phone number’ 134, and ‘payment preference’ 136. In the original tab strip control, currently, ‘customer data’ 104 tab is selected and is active and the remaining tabs ‘sales order’ 106, and ‘shipping info’ 108 are inactive. The inactive tab pages are also referred to as deactivated tab pages. At any given point of time one tab page that is selected remains in active state, and the rest of the tab pages that are not selected remain in inactive state. The selected active tab page is visible in the enterprise GUI, and the deactivated tabs that not selected may not be visible in the ‘enterprise GUI’. When a deactivated tab page is selected for activation, the deactivated tab page is activated and is visible in the ‘enterprise GUI’. To update data fields in an inactive tab, the inactive tab is clicked or selected using a data exchange algorithm to automatically activate, and update the data fields. Automatic activation refers to activation of the tab by the data exchange algorithm automatically without human intervention.

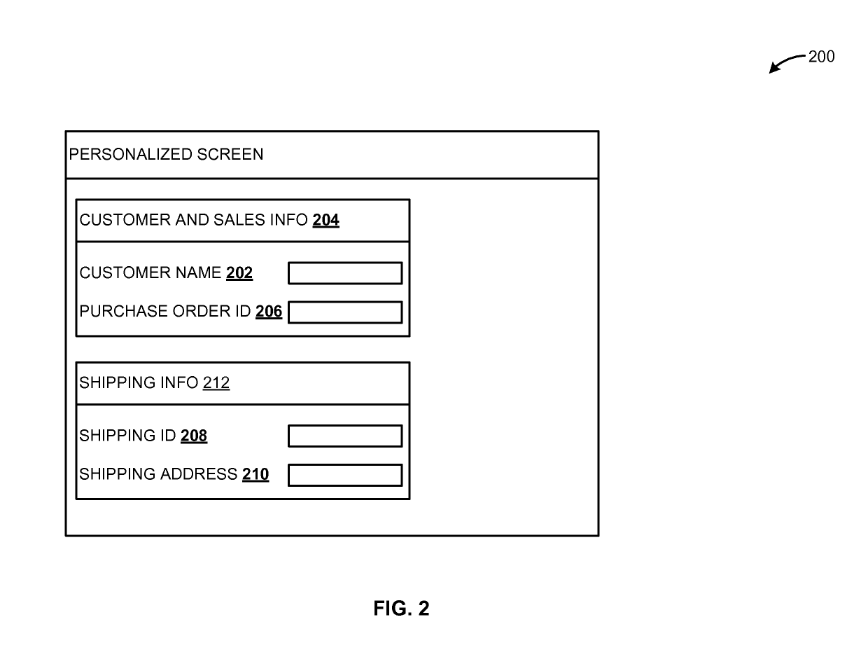

The ‘enterprise GUI’ screens or ERP screens can be personalized to improve user experience and productivity by simplifying the screens. The screens can be personalized based on roles and responsibilities of a user. The data fields can be selected and added from across various tab pages in the tab strip to the personalized screen or personalized graphical user interface (GUI) or personalized user interface. FIG. 2 is a block diagram illustrating exemplary personalized screen 200 with data from various tab pages of ‘enterprise GUI’ 100, according to one embodiment. The personalized screen 200 may include data fields from across various tab pages such as customer data 104, sales order 106, and shipping info 108 of FIG. 1. The data field ‘customer name’ 110 from tab page customer data 104 is added in the personalized screen as ‘customer name’ 202 in ‘customer and sales info’ 204 window. Similarly, data field ‘purchase order id’ 120 from tab page sales order 106 is added in the personalized screen as ‘purchase order id’ 206 in ‘customer and sales info’ 204 window. The data field ‘shipment id’ 130 and ‘shipping address’ 132 from tab page shipping info 108 is added in the personalized screen as ‘shipping id’ 208 and ‘shipping address’ 210 in ‘shipping info’ 212 window.

Though the data fields ‘purchase order id’ 206, ‘shipping id’ 208 and ‘shipping address’ 210, are visible in the personalized screen, they are from inactive tab pages sales order 106 and shipping info 108 in the original tab strip control 102. When data is input in data fields ‘purchase order id’ 206, ‘shipping id’ 208 and ‘shipping address’ 210, the inactive tab pages ‘sales order’ 106 and ‘shipping info’ 108 in the original tab strip control 102 have to be automatically activated to update the data. To enable such data exchange or read/write of data to and from the personalized screen to deactivated tab pages in an original tab strip control, proxies are used. In this document, a proxy is a control with functionalities similar to an original control. A proxy control may be located in a personalized screen. Life time of the proxy control is bound to lifetime of the personalized screen, if the personalized screen is deleted the proxy control is deleted. The proxy control is visible to an end user, and the original control is hidden from the end user. For example, a data field may have a proxy control with functionalities similar to the data field. Data exchange algorithm can be used to efficiently exchange data or read/write data between original controls in deactivated tabs and the personalized screen via proxy controls.

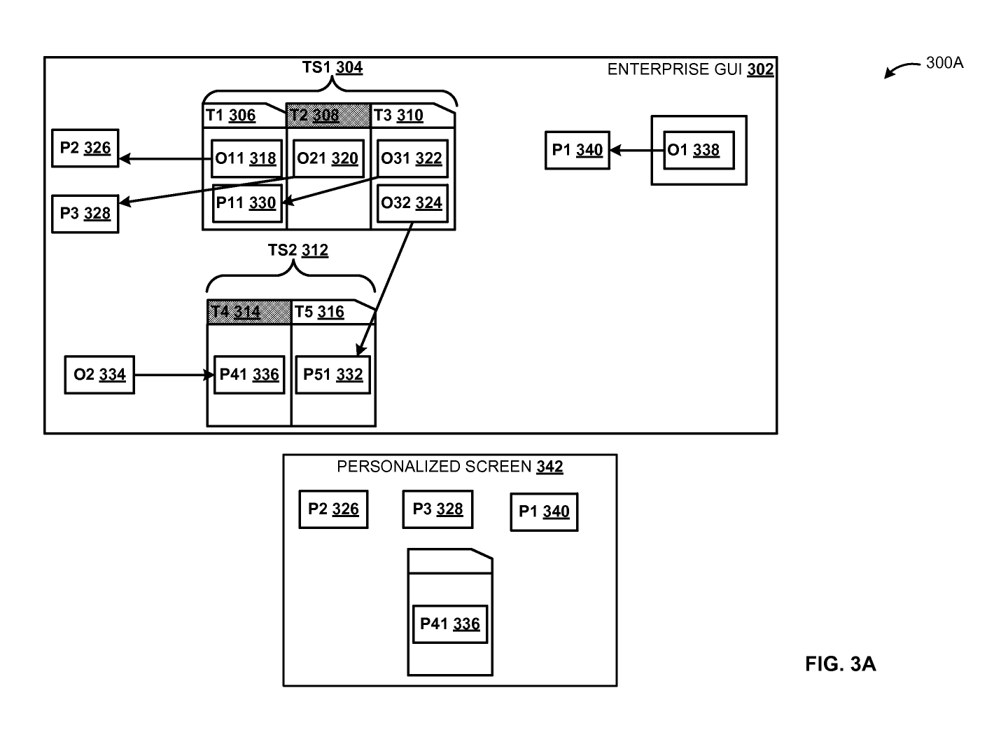

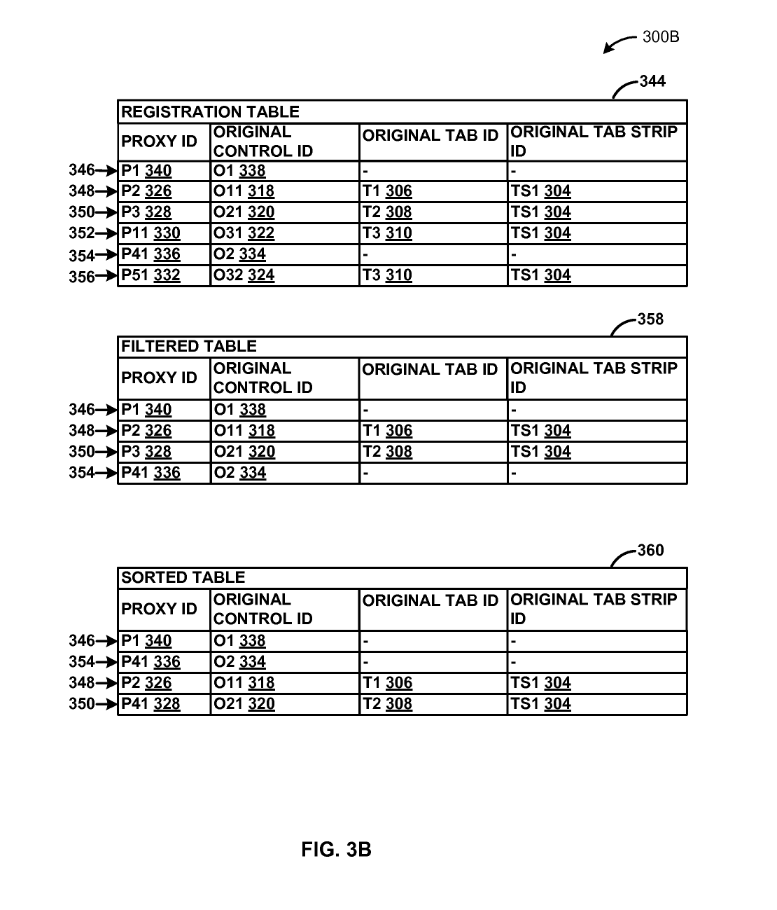

FIG. 3A is a block diagram and FIG. 3B is a set of table in combination illustrating data exchange using proxies 300A and generated tables 300B, according to one embodiment. In ‘enterprise GUI’ 302, a tab strip ‘TS1’ 304 is shown containing tab pages ‘T1’ 306, ‘T2’ 308 and ‘T3’ 310, and tab strip ‘TS2’ 312 is shown containing tab pages ‘T4’ 314 and ‘T5’ 316. Tab page ‘T1’ 306 has original control ‘O11’ 318, tab page ‘T2’ 308 has original control ‘O21’ 320 and tab page ‘T3’ 310 has original control ‘O31’ 322 and ‘O32’ 324. ‘Enterprise GUI’ 302 may be displayed in a single window or multiple windows as stacked modal windows. For the individual original controls corresponding proxy controls are generated. The proxy controls are bound to its original controls by binding the original control identifiers represented as ‘orginalcontrolID’. The proxy controls are registered with a proxy manager component (not illustrated) that is responsible for reading/writing data from/to the original controls and the proxy controls. For the original control ‘O11’ 318 a proxy control ‘P2’ 326 is generated, for ‘O21’ 320 a proxy control ‘P3’ 328 is generated, for ‘O31’ 322 proxy control ‘P11’ 330 is generated, for ‘O32’ 324 proxy control ‘P51’ 332 is generated. In tab strip TS2 312, for original control ‘O2’334 proxy control ‘P41’ 336 and for ‘O1’ 338 proxy control ‘P1’ 340 are generated. The proxy controls ‘P2’ 326, ‘P3’ 328, ‘P11’ 330, ‘P51’ 332, ‘P41’ 336 and ‘P1’ 340 are registered with the proxy manager.

The proxy controls ‘P2’ 326, ‘P3’ 328, ‘P1’ 340 and ‘P41’ 336 may be available in personalized screen 342, if a user adds the proxy controls to the personalized screen 342. In the example considered, tab pages ‘T2’ 308 and ‘T4’ 314 are active, and the tab pages ‘T1’ 306, ‘T3’ 310 and ‘T5’ 316 are inactive. The proxy controls ‘P11’ 330 and ‘P51’ 332 on the inactive tabs are not visible in the screen in the ‘enterprise GUI’ 302. When the proxies are generated for the original control, the proxies are registered with the proxy manager component, and registration table 344 is generated as shown in FIG. 3B. The registration table 344 also includes information on the tab page identifier referred to as ‘tab ID’, and the tab strip identifier referred to as ‘tab strip ID’ to which the original control belongs to. The first row 346 in the registration table 344 shows entry with ‘proxy ID’ ‘P1’ 340 associated with ‘original control ID’ ‘O1’ 338, identifier ‘P1’ 340 is used to uniquely identify the proxy created for the original control ‘O1’ 338. The original control ‘O1’ 338 is available outside the tab strip controls ‘TS1’ and ‘TS2’ and is always visible in the ‘enterprise GUI’ 302. Accordingly, ‘original tab ID’ and ‘original tab strip ID’ are nil indicated by ‘-’. Second row 348, shows entry ‘proxy ID’ ‘P2’ 326 associated with the original control ‘O11’ 318. Original control ‘O11’ 318 is available in tab page ‘T1’ 306 in tab strip ‘TS1’ 304, accordingly ‘original tab ID’ is ‘T1’ 306 and ‘original tab strip ID’ is ‘TS1’ 304.

Similarly, third row 350, shows entry with proxy ID ‘P3’ 328 associated with original control ‘O21’ 320. Original control ‘O21’ 320 is available in tab page ‘T2’ 308 and tab strip ‘TS1’ 304, accordingly ‘original tab ID’ is ‘T2’ 308 and ‘original tab strip ID’ is ‘TS1’ 304. Fourth row 352, shows entry with proxy ID ‘P11’ 330 associated with original control ‘O31’ 322. Original control ‘O31’ 322 is available in tab page ‘T3’ 310 in tab strip ‘TS1’ 304, accordingly ‘original tab ID’ is ‘T3’ 310 and ‘original tab strip ID’ is ‘TS1’ 304. Fifth row 354, shows entry with proxy ID ‘P41’ 336 associated with original control ‘O2’ 334. Original control ‘O2’ 334 is available outside the tab strips ‘TS1’ 304 and ‘TS2’ 312, accordingly ‘original tab ID’ and ‘original tab strip ID’ are nil indicated by ‘-’. Sixth row 356, shows entry with proxy ID ‘P51’ 332 associated with original control ‘O32’ 324. Original control ‘O32’ 334 is available in tab page ‘T3’ 310 in tab strip ‘TS1’ 304, accordingly ‘original tab ID’ is ‘T3’ 310 and ‘original tab strip ID’ is ‘TS1’ 304.

The entries in the registration table 344 are filtered to remove the proxies that are currently not visible in the ‘enterprise GUI’. In this example considered above, tab pages ‘T2’ 308 and ‘T4’ 314 are active, accordingly proxy controls ‘P11’ 330 in the inactive tab ‘T1’ 306 and ‘P51’ 332 in the inactive tab ‘T5’ are not visible in the ‘enterprise GUI’ 302. In the filtered table 358, fourth row 352 with entry ‘P11’ 330 and sixth row 356 with entry ‘P51’ 332 are filtered. The entries in the filtered table 358 are sorted by ‘original tab ID’ and ‘original tab strip ID’ in sorted table 360. Sorting by ‘original tab ID’ and ‘original tab strip ID’ ensures that when a tab page is automatically activated once, the proxy controls in the tab page are updated one after other. Multiple independent activation of the same tab page is avoided.

By way of example, data exchange using proxies is illustrated below with reference to FIG. 3A and FIG. 3B. An input is received in the proxy controls ‘P1’ 340 and ‘P2’ 326 in the personalized screen 342 of FIG. 3A. Based on the received input, data exchange algorithm is invoked. The registration table 344 is looked up for proxy entries. The entries in the registration table 344 are filtered to remove the proxies that are currently not visible in the ‘enterprise GUI’ 302. The entries in the filtered table 358 are sorted by ‘original tab ID’ and ‘original tab strip ID’ in sorted table 360. For individual proxy entries in the sorted table 360, the following steps are repeated. For proxy entry ‘P1’ 340 in the first row 346, the ‘original tab ID’ is determined to be ‘null’. This implies that the proxy control ‘P1’ 340 is visible in the ‘enterprise GUI’ 302 and is not in any tab strip. Accordingly, data exchange between the proxy control and the original control is initiated. Proxy manager enables data exchange between the proxy control and the original control. If the input received in ‘P1’ 340 is in ‘read’ mode, data is read from the original control ‘O1’ 338 to the proxy control ‘P1’ 340. If the input received in ‘P1’ 340 is not in ‘read’ mode i.e. write mode, data is written into original control ‘O1’ 338 from the proxy control ‘P1’ 340.

The above steps are repeated for the next proxy entries ‘P41’ 336, ‘P2’ 326 and ‘P3’ 350. However, since the input is received in the proxy controls ‘P1’ 340 and ‘P2’ 326 and not in ‘P41’ 336 and ‘P3’ 328, proxy controls ‘P41’ 336 and ‘P3’ 328 does not need a read or write therefore is no data exchange between proxy controls and original controls. For the next proxy entry ‘P2’ 326 in the third row 348, the ‘original tab ID’ is determined to be ‘T1’ 306. It is determined that tab page ‘T1’ 306 is not already active, and accordingly tab page ‘T1’ 306 is automatically activated, and an update proxy function is invoked to initiate data exchange between the proxy controls and the original controls. Proxy manager enables data exchange between the proxy controls and the original controls. If the input received in ‘P2’ 326 is in ‘read’ mode, data is read from the original control ‘O11’ 318 to the proxy control ‘P2’ 326. If the input received in ‘P2’ 326 is not in ‘read’ mode, data is written into original control ‘O11’ 318 from the proxy control ‘P2’ 326.

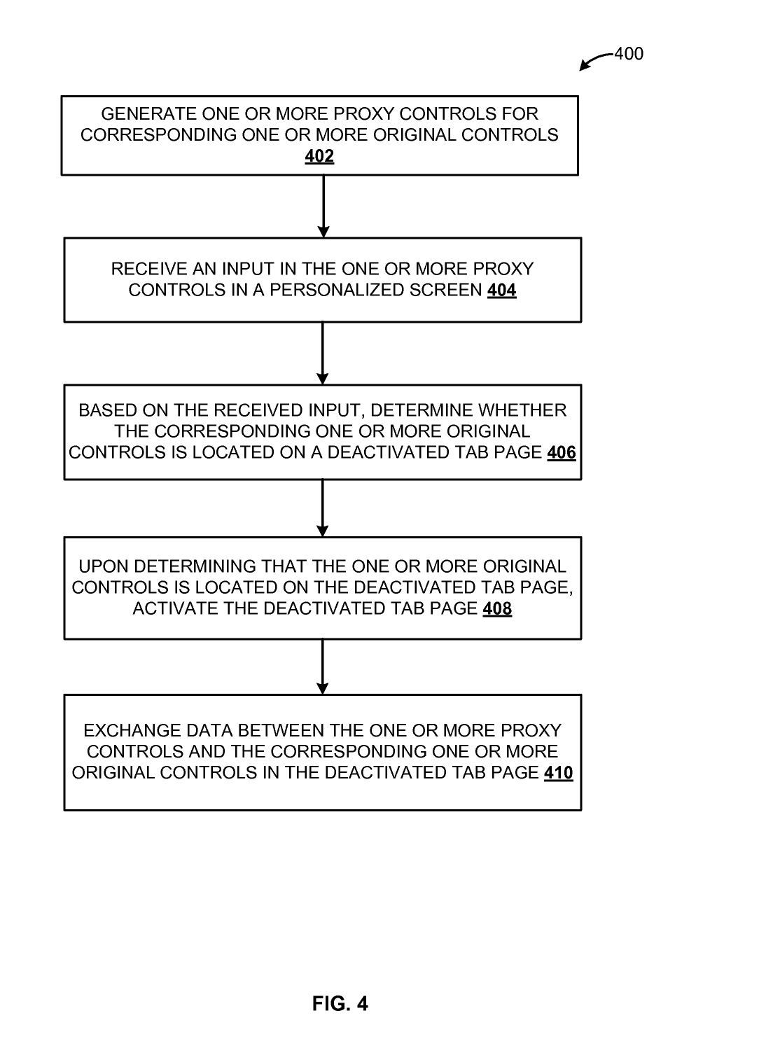

FIG. 4 is high level flow diagram illustrating process 400 of data exchange using proxy, according to one embodiment. At 402, one or more proxy controls are generated for corresponding one or more original controls. The one or more proxy controls may be registered in a registration table. A set of proxy controls are filtered from the registration table to generate a filtered table. The one or more proxy controls in the filtered table are sorted by tab identifiers and tab strip identifiers to generate a sorted table. At 404, an input is received in the one or more proxy controls in a personalized screen. The input received may be in a read mode or write mode. At 406, based on the received input, it is determined whether the corresponding one or more original controls is located on a deactivated tab page. Upon determining that the corresponding one or more original controls is located on the deactivated tab page, at 408, the deactivated tab page is activated. At 410, data is exchanged between the one or more proxy controls and the corresponding one or more original controls in the deactivated tab page. In data exchange, if the input received is in read mode, data is read from the one or more original controls to the one or more proxy controls. In data exchange, if the input received is not in read mode i.e. write mode, data is written into the one or more original controls from the one or more proxy controls.

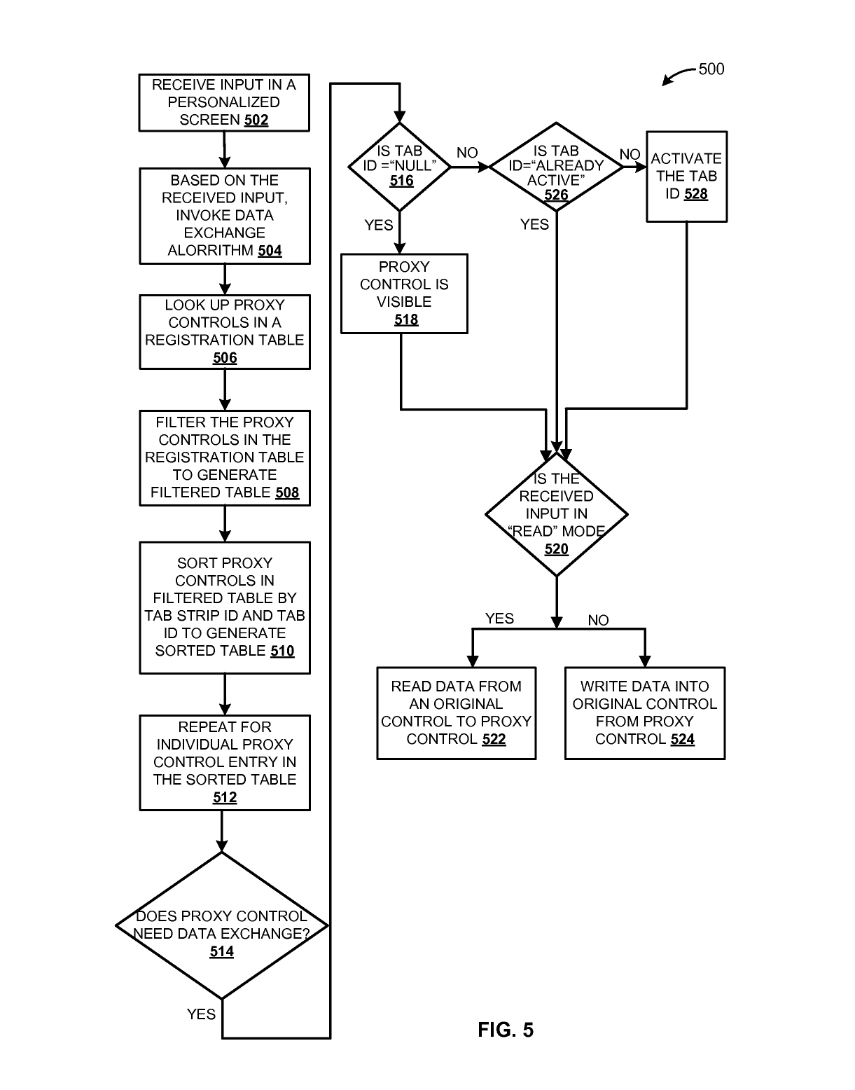

FIG. 5 is detailed flow diagram illustrating process 500 of data exchange using proxy, according to one embodiment. The flow diagram 500 is explained with reference to tables in FIG. 3B. At 502, an input is received in a personalized screen. Input may be data entry or activation of proxy controls in the personalized screen. At 504, based on the received input, data exchange algorithm is invoked. At 506, proxy controls in registration table 344 of FIG. 3B are looked up. At 508, the proxy controls in the registration table 344 are filtered to generate filtered table 358. The proxy controls are filtered to remove the proxy controls that are currently not visible in the ‘enterprise GUI’. At 510, the proxy controls in the filtered registration table 358 are sorted by tab ID (original tab ID) and tab strip ID (original tab strip ID) to generate sorted table 360. At 512, for the individual proxy control entry in the sorted table 360, steps 514 to 524 are repeated. At 514, it is determined whether the proxy entry needs data exchange. Upon determining that the proxy entry needs data exchange, at 516, it is determined whether the tab ID (original tab ID) is ‘null’ for the proxy entry. Upon determining that the tab ID is ‘null’, at 518, it is inferred that the proxy control is visible in the ‘enterprise GUI’ and is not in any of the tabs. At 520, it is determined whether the received input is in ‘read’ mode. Upon determining that the input received is in ‘read’ mode, at 522, data is read from an original control to the proxy control. Alternatively, upon determining that the input received is not in ‘read’ mode i.e. write mode, at 524, data is written into an original control from the proxy control. Upon determining that the tab ID is not ‘null’, at 526, it is determined whether the tab ID is already active. Upon determining that the tab ID is already active, steps 520 and 522, or steps 520 and 524 are executed as appropriate. Upon determining that the tab ID is not already active, at 528, the tab ID or tab page is automatically activated, and steps 520 and 522, or steps 520 and 524 are executed as appropriate.

Personalization of screen helps simplify process, improve usability, and increases user productivity. While personalizing the screens, data fields in various tab strips of the ERP solution can be used in the personalized screen in different locations and different sequence. Data exchange using proxies enables efficient automatic activation of deactivated tab pages, and once a deactivated tab page is activated, the individual proxy controls in the tab page is handled to exchange data to and from corresponding original controls. The number of activation of tab pages is optimized by avoiding multiple navigation between the tab pages.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

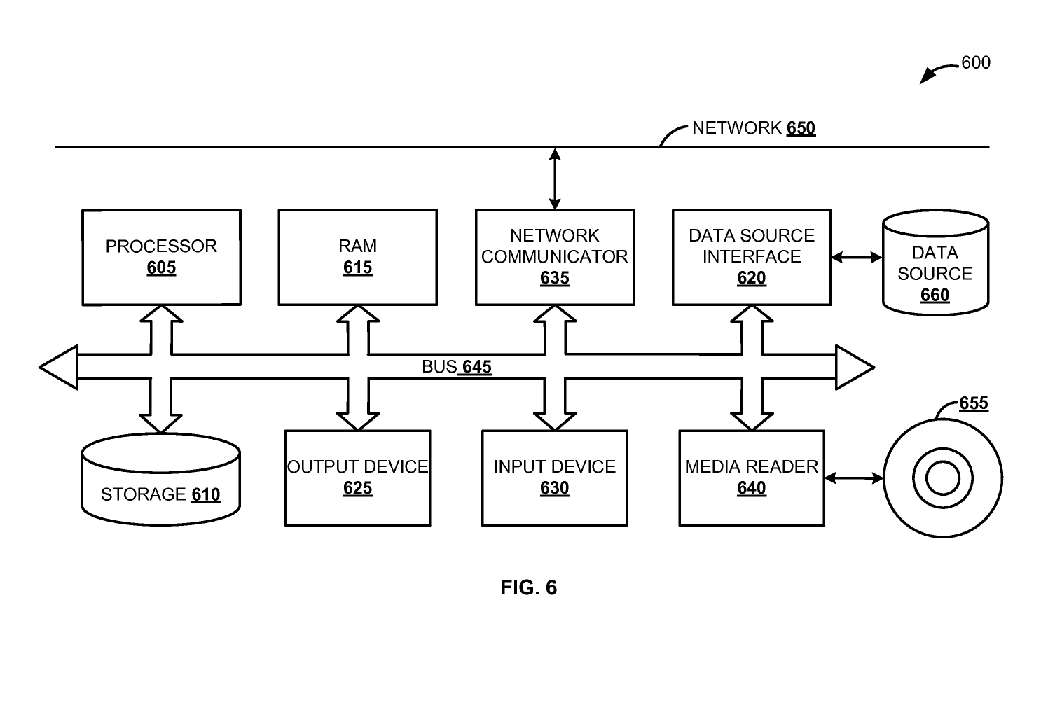

FIG. 6 is a block diagram illustrating an exemplary computer system 600, according to an embodiment. The computer system 600 includes a processor 605 that executes software instructions or code stored on a computer readable storage medium 655 to perform the above-illustrated methods. The processor 605 can include a plurality of cores. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. According to some embodiments, such as some in-memory computing system embodiments, the RAM 615 can have sufficient storage capacity to store much of the data required for processing in the RAM 615 instead of in the storage 610. In some embodiments, all of the data required for processing may be stored in the RAM 615. The stored instructions may be further compiled to generate other representations of the instructions and dynamically stored in the RAM 615. The processor 605 reads instructions from the RAM 615 and performs actions as instructed. According to one embodiment, the computer system 900 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments and examples are described herein for illustrative purposes, various equivalent modifications are possible within the scope, as those skilled in the relevant art will recognize. These modifications can be made in light of the above detailed description.

What is claimed is:

1. A non-transitory computer-readable medium to store instructions, which when executed by a computer, cause the computer to perform operations comprising:
generate one or more proxy controls for corresponding one or more original controls;
receive an input in the one or more proxy controls in a personalized user interface;
based on the received input, determine whether the corresponding one or more original controls is located on a deactivated tab page;
upon determining that the one or more original controls is located on the deactivated tab page, automatically activate the deactivated tab page; and
exchange data between the one or more proxy controls and the corresponding one or more original controls in the deactivated tab page.

2. The computer-readable medium of claim 1, wherein, exchange data further cause the computer to perform operations:
upon determining that the received input is in read mode, read data from the one or more original controls to the one or more proxy controls.

3. The computer-readable medium of claim 1, wherein, exchange data further cause the computer to perform operations:
upon determining that the input received is in write mode, write data into the one or more original controls from the one or more proxy controls.

4. The computer-readable medium of claim 1, to store instructions, which when executed by the computer, cause the computer to perform operations:
register the one or more proxy controls in a registration table;
in the registration table, filter a set of proxy controls currently not visible in the personalized user interface to generate a filtered table; and
sort the one or more proxy controls by tab identifiers and tab strip identifiers to generate a sorted table.

5. The computer-readable medium of claim 1, to store instructions, which when executed by the computer, cause the computer to perform operations:
upon determining that the corresponding one or more original controls is located on an already activated tab page, exchange data between the one or more proxy controls and the corresponding one or more original controls.

6. The computer-readable medium of claim 1, to store instructions, which when executed by the computer, cause the computer to perform operations:
upon determining that the corresponding one or more original controls is not located on the deactivated tab page and the already activated tab page, automatically activate the deactivated tab page; and
exchange data between the one or more proxy controls and the corresponding one or more original controls.

7. The computer-readable medium of claim 1, wherein the one or more original controls is located in a modal window in an enterprise application.

8. A computer-implemented method of data exchange between proxies, the method comprising:
generating one or more proxy controls for corresponding one or more original controls;
receiving an input in the one or more proxy controls in a personalized user interface;
based on the received input, determining whether the corresponding one or more original controls is located on a deactivated tab page;
upon determining that the one or more original controls is located on the deactivated tab page, automatically activating the deactivated tab page; and
exchanging data between the one or more proxy controls and the corresponding one or more original controls in the deactivated tab page.

9. The method of claim 8, wherein, exchange data further causes the computer to:
upon determining that the received input is in read mode, reading data from the corresponding one or more original controls to the one or more proxy controls.

10. The method of claim 8, wherein, exchange data further cause the computer to perform operations:
upon determining that the input received is in write mode, writing data into the corresponding one or more original controls from the one or more proxy controls.

11. The method of claim 8, further comprising instructions which when executed by the computer further causes the computer to:
registering the one or more proxy controls in a registration table;
in the registration table, filtering a set of proxy controls currently not visible in the personalized user interface to generate a filtered table; and
sorting the one or more proxy controls by tab identifiers and tab strip identifiers to generate a sorted table.

12. The method of claim 8, further comprising instructions which when executed by the computer further causes the computer to:
upon determining that the corresponding one or more original controls is located on an already activated tab page, exchanging data between the one or more proxy controls and the corresponding one or more original controls.

13. The method of claim 8, further comprising instructions which when executed by the computer further causes the computer to:
upon determining that the corresponding one or more original controls is not located on the deactivated tab page and the already activated tab page, automatically activate the deactivated tab page; and
exchanging data between the one or more proxy controls and the corresponding one or more original controls.

14. The method of claim 8, wherein the one or more original controls is located in a modal window in an enterprise application.

15. A computer system for data exchange using proxies, comprising:
a computer memory to store program code; and
a processor to execute the program code to:
generate one or more proxy controls for corresponding one or more original controls;
receive an input in the one or more proxy controls in a personalized user interface;
based on the received input, determine whether the corresponding one or more original controls is located on a deactivated tab page;
upon determining that the corresponding one or more original controls is located on the deactivated tab page, automatically activate the deactivated tab page; and
exchange data between the one or more proxy controls and the corresponding one or more original controls in the deactivated tab page.

16. The system of claim 15, wherein, exchange data further causes the computer to:
upon determining that the received input is in read mode, read data from the corresponding one or more original controls to the one or more proxy controls.

17. The system of claim 15, wherein, exchange data further causes the computer to:
upon determining that the input received is in write read mode, write data into the corresponding one or more original controls from the one or more proxy controls.

18. The system of claim 15, further comprising instructions which when executed by the computer further causes the computer to:
register the one or more proxy controls in a registration table;
in the registration table, filter a set of proxy controls currently not visible in the personalized user interface to generate a filtered table; and
sort the one or more proxy controls by tab identifiers and tab strip identifiers to generate a sorted table.

19. The system of claim 15, further comprising instructions which when executed by the computer further causes the computer to:
upon determining that the corresponding one or more original controls is located on an already activated tab page, exchange data between the one or more proxy controls and the corresponding one or more original controls.

20. The system of claim 15, further comprising instructions which when executed by the computer further causes the computer to:
upon determining that the corresponding one or more original controls is not located on the deactivated tab page and the already activated tab page, automatically activate the deactivated tab page; and
exchange data between the one or more proxy controls and the corresponding one or more original controls.
